(19) United States
(12) Patent Application Publication
(10) Pub. No.: US 2017/0054590 A1
(43) Pub. Date: Feb. 23, 2017

(54) Multi-Tenant Persistent Job History Service for Data Processing Centers

(71) Applicants: Rohit Agarwal, Mountain Veiw, CA (US); Abhishek Das, Bangalore (IN); Abhishek Modi, Bangalore (IN)

(72) Inventors: Rohit Agarwal, Mountain Veiw, CA (US); Abhishek Das, Bangalore (IN); Abhishek Modi, Bangalore (IN)

(21) Appl. No.: 15/243,918

(22) Filed: Aug. 22, 2016

Related U.S. Application Data
(60) Provisional application No. 62/208,496, filed on Aug. 21, 2015.

(51) Int. Cl. H04L 12/24; H04L 29/08

(52) U.S. Cl. CPC H04L 41/069; H04L 67/10; H04L 41/22; H04L 67/146; H04L 67/2814; H04L 67/1097

(57) ABSTRACT

The present invention is generally directed to systems and methods of providing access to logs and/or history information for jobs that were processed or run on a cluster that was automatically terminated. In some embodiments, systems may include a persistence component, configured to save job history, configuration, and/or log files related to a cluster even after the cluster is terminated; a terminated job history server, configured to serve requests for logs and histories associated with jobs that ran on terminated clusters; and a cluster proxy, providing a proxy layer to redirect requests regarding terminated cluster job history, configuration, and/or log files to the terminated job history server. Methods may include directing by a cluster proxy a user request to a terminated job history server and providing, by the terminated job history server through access to a storage facility, access to logs and/or history information requested by the user.

### FIELD OF THE INVENTION

In general, the present invention is directed to a history service for data processing centers that employ automatically scaling system. More specifically, the present invention is directed to a history service that provides logs and histories for jobs that ran on clusters that were automatically terminated.

### BACKGROUND

In general, a data processing center may utilizing auto-scaling clusters to reduce costs. Such clusters may be configured using Hadoop/YARN, Presto. etc., and may run Spark, Tez, Map-Reduce. Presto-Query, etc. According to workload demands and to provide cost savings, such clusters may shut down automatically when there is a period of inactivity. However, such automatic shutdown of clusters often presents an additional challenge if debugging is needed. For example, a nightly job may fail prompting a user to investigate the reasons for the failure. If the data processing center is on-premises and always set up, each job may have an associated job server running inside the cluster that may provide access to logs. For example, the MR Job History Server or Spark History Server may provide access to the logs of Map-Reduce jobs or Spark jobs respectively. Application timeline server may provide access to other jobs of other applications, such as (for example) Tez running on YARN. However, if a processing Hadoop cluster was shutdown (for example, due to inactivity), the Job History server may no longer be running, thereby failing to provide a user with logs that may be useful in debugging, or for other purposes.

Accordingly, there is a need for a service that provides access to logs and history for jobs that ran on auto-terminated clusters.

### SUMMARY OF THE INVENTION

Some aspects in accordance with some embodiments of the present invention may include a system for providing access to logs and/or history information for jobs that were processed or run on a cluster that was automatically terminated, the system comprising a persistence component, configured to save job history, configuration, and/or log tiles related to a cluster even after the cluster is terminated; a terminated job history server, configured to serve requests for logs and histories associated with jobs that ran on terminated clusters; and a cluster proxy, providing a proxy layer to redirect requests regarding terminated cluster job history, configuration, and/or log files to the terminated job history server.

Some aspects in accordance with some embodiments of the present invention may comprise a method of providing access to logs and/or history information for jobs that were processed or run on a cluster that was automatically terminated, the method comprising: saving job history and/or log files associated with ephemeral clusters in a persistent storage facility; receiving a request from a user for information pertaining to a job, the request received at a cluster proxy; determining by the cluster proxy if the request pertains to a job that was processed or run on a terminated cluster; upon a determination that the request pertains to a job that was processed or run on a terminated cluster, directing by the cluster proxy the user request to a terminated job history server; and providing, by the terminated job history server through access to a storage facility, access to logs and/or history information requested by the user.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary system configuration, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, the present invention is directed to a service that may provide access to logs and/or history for jobs that ran on auto-terminated clusters. Users may access jobs on running and scaled-down clusters transparently through a common flow. Such a service may assist in providing a user with an experience of an always-on persistent YARN/Presto cluster, when the cluster may be comprised of a series of ephemeral clusters. Due to the large number of clusters used at any time, such a service may be secure, reliable, scalable and multi-tenant.

In accordance with some embodiments of the present invention, the service may be comprised of three (3) components: (i) persistence; (ii) a Terminated Job History Server; and (iii) a Cluster Proxy.

In general, the persistence component may confirm or ensure that the Job History, Configuration, and/or Container/Task Log files are persisted somewhere, such that such records may be accessible even after a cluster is terminated.

In the persistence component, specific examples of Map-Reduce or Tez jobs on YARN clusters may be accessed. By default, the MR (Map-Reduce) Job History Server stores history and configuration files in HDFS (Hadoop Distributed File System). This may be controlled by the property mapreduce.jobhistory.done-dir. Similarly, when log aggregation is enabled, YARN may store container logs in HDFS. In case of other YARN applications, such as Tez, the job history and related configurations may be stored in an embedded database called, for example, leveldb. This may be controlled by the property yarn.nodemanager.remote-app-log-dir. In order to make available such history, configuration and log files even after a cluster is shut down, such information may be stored in a storage facility 170, such as but not limited to Amazon S3 (Simple Storage Service, a highly durable and scalable object store. Accordingly, above properties were set to the users' storage facility location. Note, however, that in some circumstances a NativeS3Fs (a NativeS3FileSystem clone) may be implemented to use a AbstractFileSystem APIs. This may be required or helpful since YARN uses such Abstract FileSystem APIs instead of the FileSystem APIs used by NativeS3FileSystem.

The Terminated Job History Server may be persistent and multi-tenant, and may serve requests for logs and histories associated with jobs that ran on terminated clusters. This may be determined by looking up persisted files from the first component. The Terminated Job History Server may be system wide, and may maintain job histories for various users/clients across numerous systems and clusters.

The Terminated Job History Server (TJHS) may be implemented once for each type of Job. For example, there may be a Map-Reduce TJHS, a Spark TJHS, or a Terminated Application Timeline Server. This server may serve requests from different users having different storage facility locations and credentials.

For Map-Reduce TJHS—a standard Hadoop Job History server may be utilized, but may be made multi-tenant by extending it to accept different values for yarn.nodemanager.remote-app-log-dir, mapreduce.jobhistory.done-dir and storage facility (i.e., S3) credentials for different requests. For Terminated Application Timeline Server, the same standard job history server may be made multi-tenant by extending it to accept similar parameters, such as the storage location of the leveldb. The original Job History server daemon may have capabilities to perform other functions that are unnecessary to its current use, and according such services web pages that are not multi-tenant may be disabled. Accordingly, the TJHS server may now run as an internal service in for a big data processor, such as Qubole. Inc. —the applicant of the present application.

The Cluster Proxy may itself maintain a Job History server for graphical user interface (GUI) access to jobs that it has run. This feature may be bundled with Presto/YARN clusters. The Cluster Proxy may provide a proxy layer to redirect requests to the correct server based on the specific job and cluster. This may direct requests to a typical job history server when available, or to the Terminated Job History Server when not available—i.e., for terminated clusters.

In general, a user interface may generate URLs of the form: http:/HOSTNAME:8088/proxy/APP_ID. However, all such URLs may be rewritten to be of the form: https://api.qubole.com/cluster-proxy?encodedUrl=<encoded http://HOSTNAME:8088/proxy/AIP_ID>. Any Ajax requests generated by a web page may also be intercepted and rewritten to fetch data from the /cluster-proxy endpoint instead. Moreover, Nginx may be run on a web server in order to redirect requests to the /cluster-proxy endpoint to the Cluster Proxy service.

The Cluster Proxy may perform the following: (i) Authentication: (ii) Authorization; and/or (iii) Routing. Authentication may be based on cookies and verifying that the request is issued by an authorized user (for example, a user that is properly signed into the system with proper appropriate credentials). Authorization may be performed by matching hostname information which came with the request against the node information stored in databases. (Note that the big data processor may maintain a complete record of all the machines provisioned by the processor).

The databases of the big data processor may also record the state of the machines that have been provisioned as well as that of the cluster to which each machine belongs. If the hostname corresponds to a terminated cluster—the request may be routed to the TJHS. If the hostname corresponds to an active cluster, the request may be routed to Hadoop JHS for such cluster.

If the request is routed to the TJHS, the proxy layer may append information about the storage facility (i.e., S3) location and credentials to retrieve the history and log files requested.

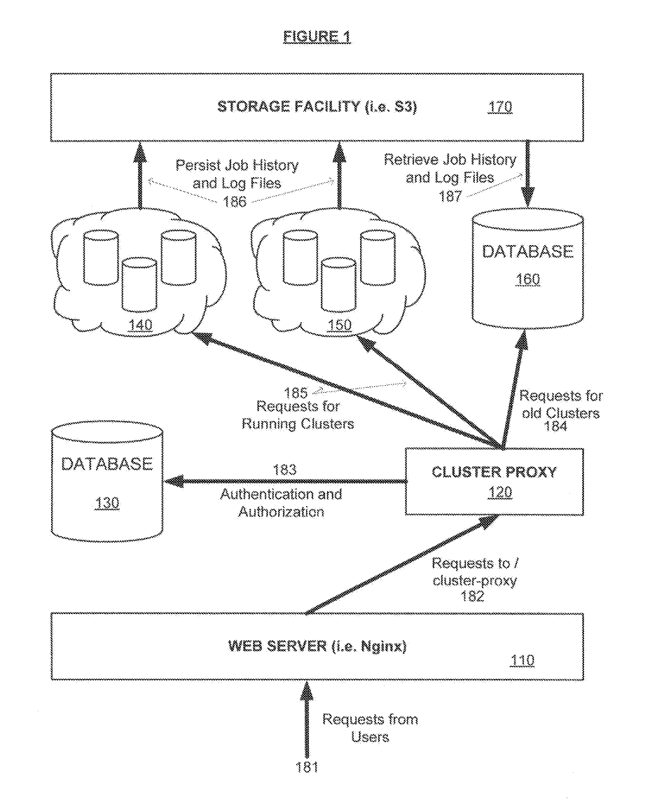

With reference to FIG. 1, an exemplary system configuration 10, in accordance with some embodiments of the present invention will now be discussed. System 10 may generally comprise a web server 110, such as but not limited to Nginx, a cluster proxy 120, a database 130, one or more running clusters 140, 150, a Terminated Job History Server 160, and a storage facility 170, such as but not limited to Amazon S3 (Simple Storage Service).

During operation, the web server 110 may receive requests from users at 181, and may send a request at 182 to the cluster proxy 120. The cluster proxy 120 may send an authentication and authorization communication 183 to database 130. Cluster proxy 120 may also send requests for running clusters 185 to one or more running clusters 140, 150. Cluster proxy 120 may also send a request for information associated with old clusters to the Terminated Job History Server 160.

The running clusters 140, 150 may then persist job history and log files to the storage facility 170. However, as noted above such information may not be available fbr clusters that terminated, for example as part of an automatic scaling function. Accordingly, the Terminated Job History Server 160 may comprise records—histories and logs—of terminated clusters. At 187 the Terminated Job History Server 160 may retrieve job history and log files for requested clusters from storage facility 170.

Note that the exemplary architecture as set forth in FIG. 1 may be extended to provide persistent history and other services associated with ephemeral clusters.

In addition, note that it may be desirable to confirm that all links contained in history pages are, and continue, working. Links generated by a job history server are generally intended to work on a running cluster, and accordingly are generally in the form http://HOSTNAME:19888/jobhistory/ . . . . If the links remained in this current format, they would be disabled since the server has gone away (i.e., from a terminated cluster). Moreover, such links may not even work for a running cluster, since running clusters may be firewalled or accessible only by the big data processor. Accordingly, before sending any page generated by a job history server, the cluster proxy may parse the html and replace the links to be in a useable form—for example, https://api.quoble.com/cluster-proxy?encodedUrl=<encoed http://HOSTNAME19888/jobbistory . . . >

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A system for providing access to logs and/or history information for jobs that were processed or run on a cluster that was automatically terminated, the system comprising:
a persistence component, configured to save job history, configuration, and/or log files related to a cluster even after the cluster is terminated;
a terminated job history server, configured to serve requests for logs and histories associated with jobs that ran on terminated clusters; and
a cluster proxy, providing a proxy layer to redirect requests regarding terminated cluster job history, configuration, and/or log files to the terminated job history server.

2. The system of claim 1, wherein the persistence component confirms or ensures that the job history, configuration, and/or log files are saved and accessible after cluster termination.

3. The system of claim 1, wherein the terminated job history server is implemented once for each type of job.

4. The system of claim 1, wherein the terminated job history server is persistent and multi-tenant.

5. The system of claim 1, wherein the cluster proxy further maintains a job history server for graphical user interface (GUI) access to jobs it has run.

6. The system of claim 1, wherein the cluster proxy is configured to perform authentication, authorization, and/or routing.

7. The system of claim 6, wherein the authentication performed by the cluster proxy is based at least in part on cookies verifying that the request is made by an authorized user.

8. The system of claim 6, wherein the authorization is performed by the cluster proxy based at least in part on matching hostname information associated with the request with stored node information.

9. The system of claim 1, wherein the cluster proxy redirects requests by appending information about a storage facility location and credentials necessary to retrieve the history and/or log files from the terminated job history server.

10. A method of providing access to logs and/or history information for jobs that were processed or run on a cluster that was automatically terminated, the method comprising:
saving job history and/or log files associated with ephemeral clusters in a persistent storage facility;
receiving a request from a user for information pertaining to a job, the request received at a cluster proxy;
determining by the cluster proxy if the request pertains to a job that was processed or run on a terminated cluster;
upon a determination that the request pertains to a job that was processed or run on a terminated cluster, directing by the cluster proxy the user request to a terminated job history server; and
providing, by the terminated job history server through access to a storage facility, access to logs and/or history information requested by the user.

11. The method of claim 10, wherein the cluster proxy appends information about a storage facility and credentials to retrieve the job history and/or log files from storage facility by the terminated job history server.

12. The method of claim 10, further comprising:
upon a determination that the request pertains to a job that is currently running on an active cluster, directing by the cluster proxy the user request to the active cluster.

13. The method of claim 12, wherein the directing by the cluster proxy the user request to the active cluster comprises directing the request to the relevant job history server of the active cluster.

14. The method of claim 10, wherein the request from the user is received via a web server, and wherein the web server sends the request to the cluster proxy.

15. The method of claim 10, wherein the cluster proxy is configured to parse any links contained in persistent job history servers to confirm that such links are in useable format and reference data stored at the storage facility.

16. The method of claim 15, wherein the storage facility comprises cloud storage.
